(19) United States
(12) Patent Application Publication
(10) Pub. No.: US 2007/0178791 A1
(43) Pub. Date: Aug. 2, 2007

(54) Material for waterproof clothing device

(76) Inventor: Li-Ying Tsai, Taoyuan City (TW)

Correspondence Address: LEONG C LEI, PMB # 1008, 1867 YGNACIO VALLEY ROAD, WALNUT CREEK, CA, 94598, US

(21) Appl. No.: 11/340,439

(22) Filed: Jan. 27, 2006

(51) Int. Cl. B32B 5/24; B32B 5/18; B32B 3/26; B32B 27/00

(52) U.S. Cl. 442/221; 442/315; 442/370; 428/304.4; 428/319.3

(57) ABSTRACT

A material for waterproof clothing devices such as diving suits is provided herein. The material mainly contains a foamed rubber layer sandwiched between a polyurethane (PU) thin layer and a flexible cloth layer. The PU thin layer is coated to the outside surface of the foamed rubber layer by release paper transfer printing and thereby forms a rugged protection cover for the layers beneath. The flexible cloth layer is pressurized to adhere to the inside surface of the foamed rubber layer to provide smooth contact with skin or with other objects. The PU thin layer and the flexible cloth layer possess good elasticity and ductility so that they can be extended and stretched along with the foamed rubber layer.

### BACKGROUND OF THE INVENTION

(a) Technical Field of the Invention

The present invention generally relates to materials for clothing devices, and more particularly to a multi-layered material for diving suits or other types of waterproof clothing devices.

(b) Description of the Prior Art

Conventional materials for diving suits or other waterproof clothing devices can be categorized as follows.

A first type of the materials is made from laminated double-sided cloth. This type of materials is rugged but lacks the required elasticity, ductility, and, especially, softness. A diving suit thus made, for example, is very difficult to put on and take off. Also due to its water absorbency, a diver would be difficult to operate underwater and the diver would be quickly exhausted. The material is also not water repellant and therefore not easy to dry. Clothing devices made of this type of materials are usually plain and are usually in the color black, as the materials are difficult to color and pattern, making these clothing devices less appealing

The second and more advanced type of materials is made by coating a thin film of lipophilic compound adhesive to a side of double-sided cloth so that colors and patterns can be applied. However, the adhesive is hazardous to human health if in direct contact with the skin. The adhesive can be dissolved by water or peeled off under the erosion of acid and alkaline. Therefore quite a few countries have already made laws against the use of this kind of materials. Setting aside the hazardous and legal issues, this type of materials also does not provide significant improvement in terms of the elasticity, ductility, water-repellence, durability against wear and tear, etc.

### SUMMARY OF THE INVENTION

The primary purpose of the present invention is to provides a new type of waterproof materials for clothing devices. This type of materials provides excellent softness, elasticity, ductility, water-repellence, durability against wear and tear. This type of materials is also insoluble in water or in other solutions, and is resistant to the etiolation when the material is exposed to ultraviolet light of the sun.

The material mainly contains a foamed rubber layer sandwiched between a polyurethane (PU) thin layer and a flexible cloth layer. One of the major characteristics of the present invention lies in the use of the foamed rubber to provide the required softness, elasticity and ductility.

The PU thin layer is coated to the outside surface of the foamed rubber layer by release paper transfer printing and thereby forms a rugged protection cover for the layers beneath. The PU thin layer provides water-repellence, durability, insolubility, and etiolation-resistance. The PU thin layer can be easily colored and pattered for making attractive clothing devices. The PU thin layer also possesses good elasticity and ductility so that it can be extended and stretched along with the foamed rubber layer.

The flexible cloth layer is pressurized to adhere to the inside surface of the foamed rubber layer to provide smooth contact with skin or with other objects. The flexible cloth layer also possesses good elasticity and ductility so that it can be extended and stretched along with the foamed rubber layer.

The material proposed by the present invention can be applied to diving suits, fishing suits, waterproof gloves, waterproof bags, or any other similar objects for use in water-related activities.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing the material according to the present invention.

FIG. 2 is a perspective view showing the structure of the material according to the present invention.

FIG. 3 is a sectional view showing the structure of the material according to the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

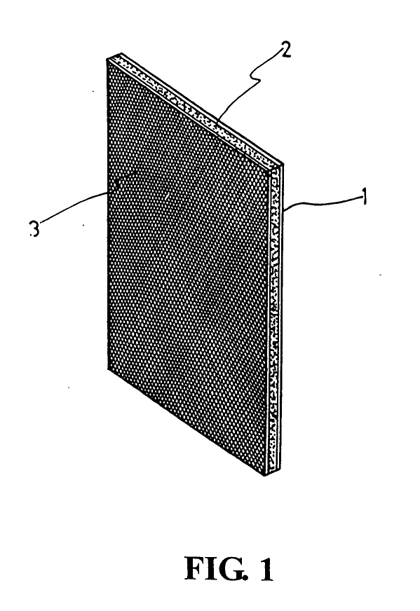

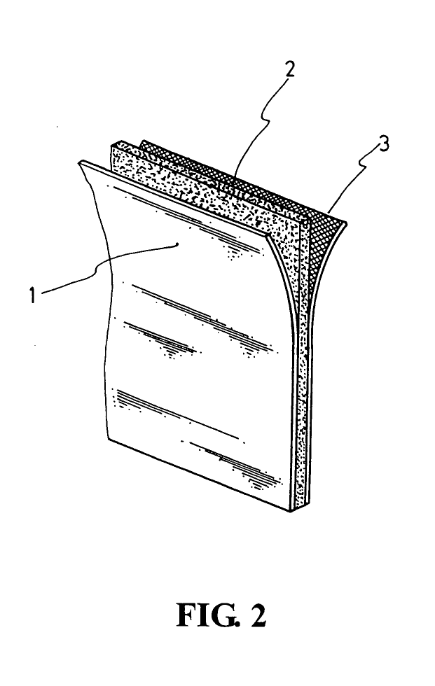

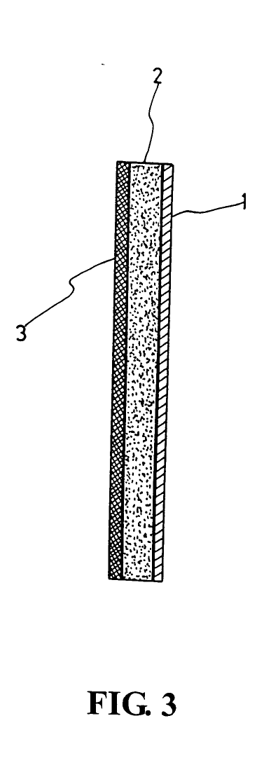

Please refer to FIGS. 1 to 3. The material mainly contains a polyurethane (PU) thin layer 1, a foamed rubber layer 2, and a flexible cloth layer 3, with the foamed rubber layer 2 sandwiched between the PU thin layer 1 and the flexible cloth layer 3.

The foamed rubber layer 2 is made by foaming soft rubber materials. The foamed rubber layer 2 provides excellent softness, elasticity, and ductility. The flexible cloth layer 3 is pressurized to adhere to the inside surface of the foamed rubber layer 2 to provide smooth contact with skin or with other objects. The flexible cloth layer 3 also possesses good elasticity and ductility so that it can be extended and stretched along with the foamed rubber layer.

The PU thin layer 1 is coated to the outside surface of the foamed rubber layer 2 by release paper transfer printing and thereby forms a rugged protection cover for the layers beneath.

As shown in FIGS. 1 to 3, the structure of the material of the present invention is similar to a piece of soft leather. It can be seamed, stretched, molded into a desired form required by the application. Most importantly, the PU thin layer 1 provides water-repellence, durability, insolubility, and etiolation-resistance. Additionally, the PU thin layer 1 can be easily colored and pattered for making attractive clothing devices. The PU thin layer 1 also possesses good elasticity and ductility so that it can be extended and stretched along with the foamed rubber layer 2.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A material for waterproof clothing devices, comprising a PU thin layer, a foamed rubber layer, and a flexible cloth layer; wherein
said foamed rubber layer is made by foaming soft rubber materials;
said flexible cloth layer is adhered to the inside surface of said foamed rubber layer; and
said PU thin layer is coated to the outside surface of said foamed rubber layer by release paper transfer printing.

2. The material according to claim 1, wherein said PU thin layer is colored and patterned.
